(19) United States
(12) Patent Application Publication
(10) Pub. No.: US 2008/0218051 A1
(43) Pub. Date: Sep. 11, 2008

(54) Socket LED device

(75) Inventors: Chi-Hao Liang, Tu Chen City (TW); Xie-Zhi Zhong, Tu Chen City (TW); Hsin-Chang Tsai, Taipei City (TW)

Correspondence Address: Joe McKinney Muncy, PO Box 1364, Fairfax, VA, 22038-1364, US

(73) Assignee: Everlight Electronics Co., Ltd., Tu Chen City (TW)

(21) Appl. No.: 11/798,270

(22) Filed: May 11, 2007

(30) Foreign Application Priority Data
Mar. 7, 2007 (TW) 96107931

(51) Int. Cl. H01J 7/24

(52) U.S. Cl. 313/45

(57) ABSTRACT

A socket LED device includes a first body, a second body, a conducting device, a heat-dissipation device and an LED module. The first body is demountably connected to the second body. The heat-dissipation device is set between the first body and the second body. The conducting device includes two conducting pins and two conducting sockets respectively located on the first connecting surface and the second connecting surface to embed with each other. The LED module is secured on the first body and includes a heat-conducting substrate touching the heat-dissipation device and a conductive portion electrically connected with the conducting pins. Therefore, the heat is gradually decreased through this kind of stacked formation.

### RELATED APPLICATIONS

This application claims priority to Taiwan Application Serial Number 96107931, filed Mar. 7, 2007, which is herein incorporated by reference.

### BACKGROUND

1. Field of Invention

The present invention relates to a socket light emitting diode device, and more particularly to a socket light emitting diode device with a heat dissipation function, and the socket may be a plastic leaded chip carrier (PLCC) socket.

2. Description of Related Art

Conventional electrical devices are mostly soldered onto a printed circuit board. The soldering temperature is about between 350 degrees Centigrade and 380 degrees Centigrade. Electrical components may be broken if the soldering or desoldering processes at high temperature are not done properly. Therefore replacing components on a printed circuit board is very inconvenient and the production cost cannot be reduced.

The heat generated by a unit area increases with an increase in the power of the electrical device. Take the high power LED for illustration, light emitting diodes have high reaction speeds, smaller volumes, lower power consumption, less heat radiation and extended lifetimes such that the light emitting diodes have therefore gradually replaced conventional lamps. In addition, the temperature produced by the unit area corresponds to the working period such that the heat may invalid the LED chip after a long working period. Therefore, the heat-dissipation function for the module becomes an important research issue.

As a result, there is a need to develop a device joining method with a heat-dissipation function to replace the conventional soldering join method to prevent the device from being damaged by the heat and supply a stable heat-dissipation effect.

### SUMMARY

It is therefore an aspect to provide a socket LED device to solve the LED chip damage problem caused by the heat during the soldering or desoldering process.

It is therefore another aspect to provide a PLCC socket with heat-dissipation that can be associated with the LED device to enhance the heat-dissipation effect.

In accordance with the foregoing description and aspects, a socket LED device is disclosed. The socket LED device includes a first body, a second body, a conducting device, a heat-dissipation device and a LED module. The first body and the second body are made of insulating material, like plastic or ceramics. The first body includes a connection surface and a first junction surface opposite to the connection surface. The second body is demountable connected to the first body and includes a second junction surface corresponding to the first junction surface. The heat-dissipation device is mounted between the first body and the second body and can be a heat-conducting block constructed as a whole or two separated heat-conducting blocks respectively set on the first junction surface and the second junction surface. The conducting device includes two conducting pins and two pin holes respectively mounted on the first junction surface and the second junction surface to embed with each other.

The LED module is associated with a socket comprising the first body, the second body, the conducting device and the heat-dissipation device. The LED module includes a heat-conducting substrate and a conductive portion. The heat-conducting substrate touches with the heat-conducting block of the heat-dissipation device and the conductive portion is electrically connected with the conducting pins of the conducting device to drive the chip of the LED module.

In an embodiment, the socket is a PLCC socket. By associating the LED module with the heat-conducting substrate and the PLCC socket with the heat-conducting block, the heat generated by the LED chip is conducted from the heat-conducting substrate to the heat-conducting block, and gradually dissipated through this stacked heat-dissipation formation. In addition, a cooling adhesive is spread in the junction between the heat-conducting blocks to raise the heat-dissipation effect. The heat-dissipation device is made of metal or ceramic. The conducting pins are electrically connected with the conductive portion of the LED module, are mounted on the first body and positioned aside the heat-conducting block such that the heat-conducting path is separated from the conductive path to obtain the thermo separation effect.

As a result, the socket LED device of the present invention has the following effects:

1. The socket LED device of the present invention includes thermo separation structure and stacked heat-conducting path to reinforce the heat-dissipation effect.

2. The connection method between the socket with heat-dissipation (such as a PLCC socket) and the LED module can be substituted for the conventional soldering method through the soldering pot to solve the LED chip damage problem caused by the heat during the soldering or desoldering process and inconvenience device replacement problem.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an exploded, schematic side view of an embodiment of a socket of a socket LED device in accordance with the present invention, and the socket is a PLCC socket with heat-dissipation;

FIG. 2 is an exploded, schematic side view of a socket LED device of an embodiment in accordance with the present invention;

FIG. 3 is an exploded, perspective view of the socket LED device in FIG. 2; and

FIG. 4 is a perspective view of a searchlight with the socket LED device.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

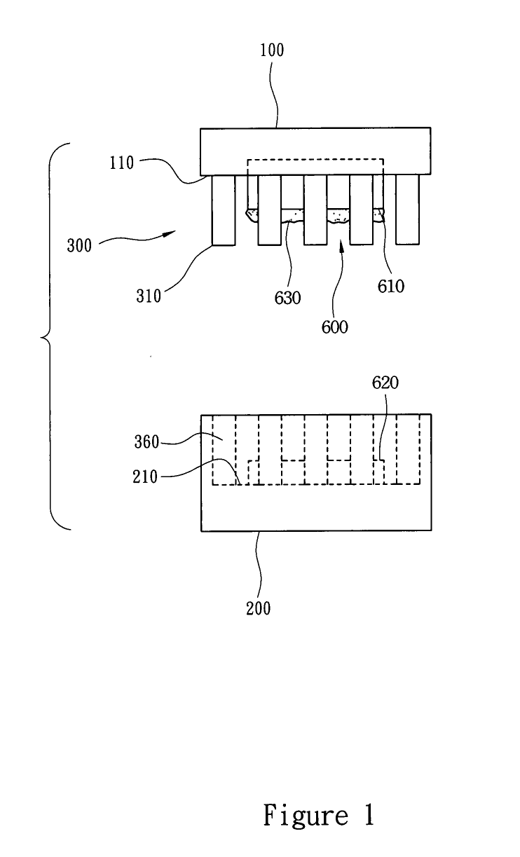

Refer to FIG. 1. FIG. 1 illustrates a schematic side view of an embodiment of a socket of a socket LED device in accordance with the present invention, and the socket is a PLCC socket with heat-dissipation. A socket LED device comprises a socket and an LED module. In this embodiment, the LED module is mounted on the socket, and the socket is a PLCC socket for illustrative purposes only. The PLCC socket with heat-dissipation includes a first body 100, a second body 200, a conducting device 300 and a heat-dissipation device 600.

The first body 100 is made of insulating material, like a plastic or a ceramic, and includes a first junction surface 110. The second body 200, is made of an insulating material, like a plastic or a ceramic, and is demountable connected to the first body 100 and includes a second junction surface 210 corresponding to the first junction surface 110. The heat-dissipation device 600 is positioned between the first body 100 and the second body 200 wherein the heat-dissipation device 600 can be a heat-conducting block constructed as a whole or two separated heat-conducting blocks as in this embodiment, a first heat-conducting block 610 and a second heat-conducting block 620. The conducting device 300 is set on the first junction surface 110 and the second junction surface 210. In this embodiment, the conducting device 300 includes multiple conducting pins 310 respectively mounted on the first junction surface 110 and multiple pin holes 360 defined in the second junction surface 210. The conducting pins 310 are respectively mounted and held in the pin holes 360.

The first heat-conducting block 610 contacts with the second heat-conducting block 620 after the conducting pins 310 inserted into the pin holes 360. In addition, a cooling adhesive 630 is spread in the junction between the first heat-conducting block 610 and the second heat-conducting block 620 to raise the heat-dissipation effect. The first heat-conducting block 610 could directly or indirectly contact with the second heat-conducting block 620 as previously described. The first heat-conducting block 610 and the second heat-conducting block 620 are made of a metal or a ceramic.

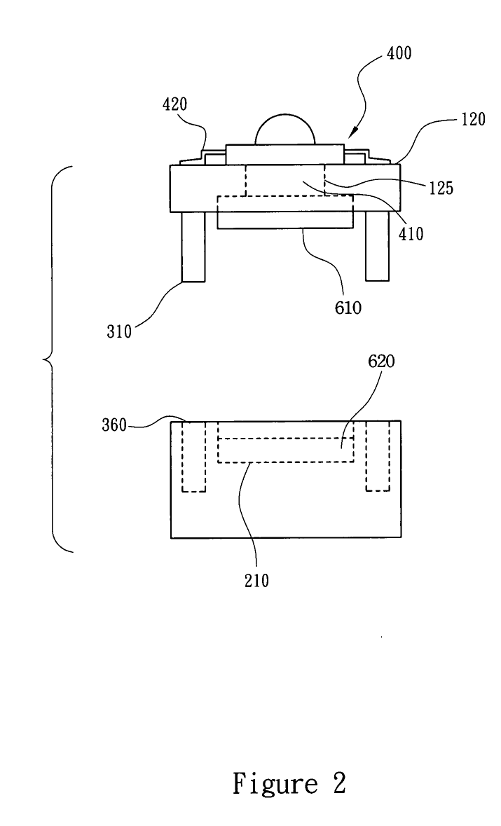

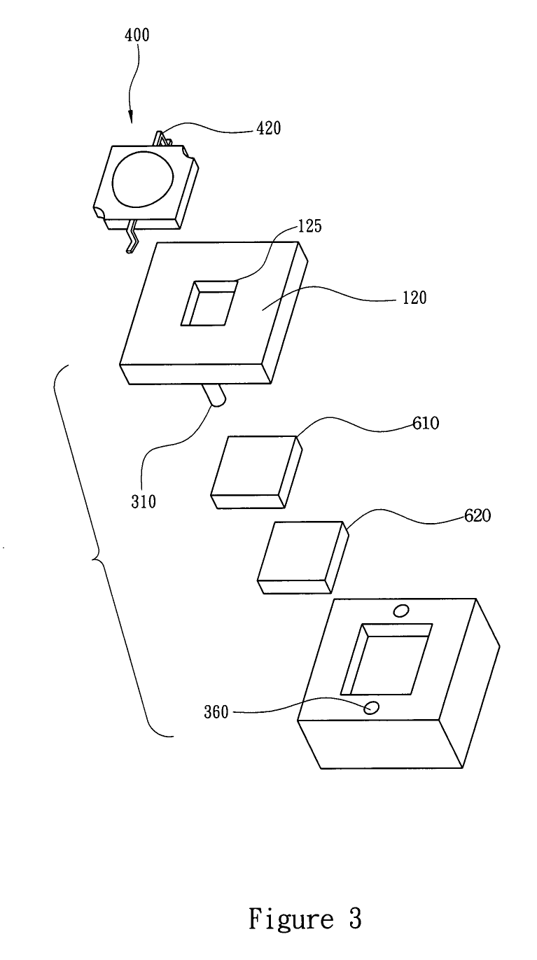

Refer to FIG. 2 and FIG. 3. FIG. 2 illustrates a schematic side view of a socket LED device of an embodiment in accordance with the present invention. FIG. 3 illustrates an exploded, perspective view of the socket LED device in FIG. 2. The socket LED device of this embodiment includes a socket with heat-dissipation and a LED module 400. The LED module 400 is mounted on the first body 100 of the socket with heat-dissipation. The design formation of the LED module 400 can be modified in accordance with the socket type.

The first body 100 further includes a connection surface 120 on which the LED module 400 is mounted. The connection surface 120 has an indentation 125. The LED module 400 includes a heat-conducting substrate 410 and a conductive portion 420. The heat-conducting substrate 410 is embedded in the indentation 125 to touch the first heat-conducting block 610, and the conductive portion 420 is electrically connected with the conducting pins 310 of the conducting device 300 to drive the chip of the LED module 400. By associating the LED module 400 with the heat-conducting substrate 410 and the socket with the first heat-conducting block 610 and the second heat-conducting block 620, the heat generated by the LED chip is conducted from the heat-conducting substrate 410 to the first heat-conducting block 610 and the second heat-conducting block 620 whereby the heat is gradually decreased through this stacked heat-dissipation formation. The conducting pins 310 electrically connected to the conductive portion 420 of the LED module 400 are mounted on the first junction surface 110 of the insulating first body 100 and positioned aside the first heat-conducting block 610 such that the heat-conducting path is separated from the conductive path to obtain the thermo separation effect.

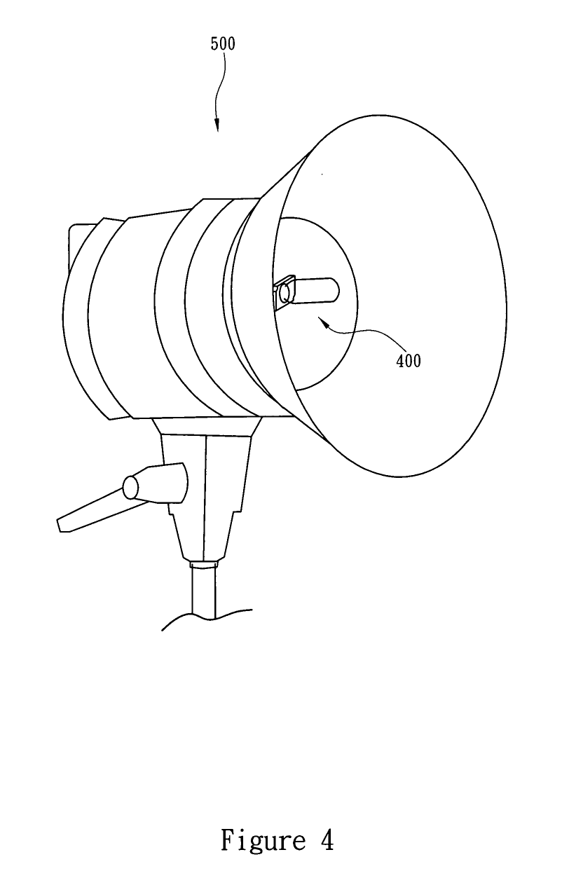

Refer to FIG. 4. FIG. 4 illustrates a perspective view of a searchlight 500 with the socket LED device. In this searchlight 500 with the embodiment of the socket LED device in accordance with the present invention, the LED module 400 associated with the first body 100, which has the conducting pins 310 can be pulled and plugged to replace. Compared with the conventional soldering replacement method, the problem of heat damage to the device is solved.

As embodied and broadly described herein, the socket LED device with a socket such as a PLCC socket with heat-dissipation of the embodiment has the following effects:

1. The socket with heat-dissipation of the present invention includes thermo separation structure and stacked heat-conducting path (the heat-conducting substrate 410, the first heat-conducting block 610 and the second heat-conducting block 620) to reinforce the heat-dissipation effect.

2. The connection method between the socket with heat-dissipation of the present invention and the LED module 400 can be substituted for the conventional soldering method through soldering pot to solve the LED chip damage problem caused by the heat during the soldering or desoldering process and inconvenience device replacement problem.

Although the present invention has been described in considerable detail with reference to certain preferred embodiments thereof, other embodiments are possible. Therefore, their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A socket LED device, comprising:
a first body comprising a connection surface and a first junction surface opposite to the connection surface;
a second body demountably connected to the first body and comprising a second junction surface corresponding to the first junction surface;
a conducting device mounted between the first junction surface and the second junction surface;
a heat-dissipation device positioned between the first body and the second body; and
an LED module secured on the connection surface of the first body and comprising a heat-conducting substrate and a conductive portion wherein the heat-conducting substrate contacts with the heat-dissipation device and the conductive portion is electrically connected with the conducting device.

2. The socket LED device of claim 1, wherein the conducting device comprises two conducting pins and two pin holes in which the conducting pins are respectively held.

3. The socket LED device of claim 1, wherein the heat-dissipation device comprises a first heat-conducting block and a second heat-conducting block respectively mounted on the first junction surface and the second junction surface.

4. The socket LED device of claim 3, wherein the heat-dissipation device comprises a cooling adhesive spread between the first heat-conducting block and the second heat-conducting block.

5. The socket LED device of claim 1, wherein the first body and the second body are made of plastic.

6. The socket LED device of claim 1, wherein the first body and the second body are made of ceramic.

7. The socket LED device of claim 1, wherein the heat-dissipation device is made of metal.

8. The socket LED device of claim 1, wherein the heat-dissipation device is made of ceramic.

9. The socket LED device of claim 4, wherein the heat-conducting substrate contacts with the first heat-conducting block of the heat-dissipation device.
